(19) United States
(12) Patent Application Publication
(10) Pub. No.: US 2003/0122880 A1
(43) Pub. Date: Jul. 3, 2003

(54) Sliderbar expanding dialogues to expose of hide dialogue content

(75) Inventors: Matthias Kloppmann, Sindelfingen (DE); Wayne F. Miller, Cary, NC (US)

Correspondence Address: Jeffrey S. LaBaw, International Business Machines, Intellectual Property Law, 11400 Burnet Rd., Austin, TX, 78758, US

(73) Assignee: INTERNATIONAL BUSINESS MACHINES CORPORATION, Armonk, NY (US)

(21) Appl. No.: 10/328,352

(22) Filed: Dec. 23, 2002

(30) Foreign Application Priority Data
Jan. 3, 2002 (GB) 02000023.8

(51) Int. Cl. G09G 5/00

(52) U.S. Cl. 345/856

(57) ABSTRACT

The present invention relates to the display of information on a screen of a computing device and in particular to method and system for displaying information including a preprogrammed expansion or reduction of the quantity of displayed information in response to an user action. In order to increase the user comfort it is proposed to provide an user interface setting means (10,20) that enables a control element (10) thereof, e.g. a slider (10) within a slider bar (20), a lever or wheel to be turned, i.e., to be moved within a predetermined setting range, and stepwise expanding or reducing the displayed information within a respective expansion range in response to respective user-initiated movements of said control element (20), without a separate user action being required for any transition between the expansion or reduction steps. Further, a quick overview about the quantity of available information can be achieved when a user explores the expansion range just by easily moving the control element (20), as e.g. the slider (20).

### 1. BACKGROUND OF THE INVENTION

1.1. Field of the Invention

The present invention relates to the display of information on a screen of a computing device. It relates in particular to method and system for displaying information including a preprogrammed expansion or reduction of the quantity of displayed information in response to a user action.

1.2. Description and Disadvantages of Prior Art

The quality of the man-machine interface (MMI) is one of the most important criteria for nearly all computer application programs running in a desktop environment, or for an application run in any embedded system because it determines the overall acceptance of the underlying program by its user. A reason for this superior significance of the MMI is that it defines the portal through which any user input into the application program, and any feedback information from the program to the user take place. Thus, for example when the MMI has a good quality a user considers himself to understand the program even in difficult situations in which a careful analysis of e.g. an initial setting dialogue of a program must be run through.

Although the present invention has a general scope for displaying information of any content, it will be compared to prior art with a respective display method which is very often used in the above-mentioned initial setting dialogues when configuring a program after initial installation, for example.

In such configuration dialogue in a desktop environment the user who wants to perform a customisation of the application program is usually confronted with a lot of information displayed on his screen. A given fraction of said information often consists in a number of so-called GUI-controls, i.e., some control input means like check boxes, OK-, or NO-, or other buttons having a given title, or input fields for specifying some information either pre-offered by the program or left at the free disposition of the user. Generally, such displayed control information on form of said GUI-controls must be filled-in or may, optionally filled-in, often in dependence of other kind of control information within a given dialogue.

The other type of information is of the type ‘read-only’ that is, for example, information having only a descriptive, illustrative character which is often used for explaining the details of a given context.

In order to give some structure to such configuration dialogue a prior art method for displaying information on the screen comprises the step of including a pre-programmed expansion or reduction of the quantity of displayed information into the dialogue control, in response to an action triggered by the user. This is, for example, a “more”-button within a given window being part of the configuration dialogue. When pressing the more-button, usually a further window pops up in prior art in which some more information is given either of the first or the second type, as described above. Sometimes, the more-button reoccurs in a window just popped up by pressing a more-button, thus implementing a nested more-mechanism.

By a repetitive occurrence of pop up windows a sequence of windows is defined as follows: a main window and one or more subordinated sub-windows which are usually dependent on each other in the given sequence. Thus, the top-level usually defines general information. Further, the lower a given pop-up window is within the sequence, the more detailed will be the information presented in a respective sub-window.

Thus, when a new window pops up as described above the new window is active, whereas the window in which the respective more-button was pressed is switched inactive. Usually, by pressing a “cancel”-button the new window can be made disappear for re-entering the window which provided the more-button. A first disadvantage of this prior art method is that it takes a long time for the user to press a more-button, read the window popping up, deciding to press a second more-button in order to explore the information offered to the user, to repeat this procedure may be a further couple of times, and possibly cancelling all or at least a part of the pop up sub-windows in order to return to the initial dialogue window in which the first “more”-button occurred.

In particular, in situations in which the location of the cancel-button or that of the more-button is not always the same the user usually moves a mouse pointer to a respective button and clicks on it for achieving the respective program response. For example for handicapped users a multiply repeated procedure as it was described above, i.e. a multiple nested more, is very laborious and prevents a user from running the nested more-dialogue a second time in an ambiguous setting procedure, for example:

When he thinks about the information given in the dialogue and is basically convinced that it should be useful to re-enter the dialogue, filling in respective GUI-controls and completing the dialogue as it seems useful in his mind, then he might consider it to be easier and more comfortable to return to some default setting which is defined in many situations at the top-level of the dialogue.

A second disadvantage in this prior art display method is that it is really impossible to get a quickly achievable impression on the range of information presented to a given subject because this requires a repeated clicking on the nested more buttons. If a user does not want to do this he will get no impression on the quantity of information basically made available for him.

A further disadvantage which is worth to be mentioned is that when a pop-up window is displayed it usually hides some content of the respective superior window. This is disadvantageous because in most cases the logic behind a given pre-programmed dialogue is easier to understand when such original information is not hidden because the user would not lose control over the context between general information and more detailed information.

1.3. Objectives of the Invention

It is thus an objective of the present invention to provide a computerised method and system for displaying information on the screen of a computing device offering more user comfort.

### 2. SUMMARY AND ADVANTAGES OF THE INVENTION

This objective of the invention is achieved by the features stated in enclosed independent claims. Further advantageous arrangements and embodiments of the invention are set forth in the respective subclaims. Reference should now be made to the appended claims.

According to its primary aspect a computerized method for displaying information on the screen of a computing device is disclosed, the method including an application-driven, preprogrammed expansion or reduction of the quantity of information in response to an action triggered by a respective user of said computing device, which is characterized by comprising the steps of:

a.) providing an user interface setting means enabling a control element thereof, e.g. a slider bar, a lever or wheel to be turned, or any other useful control element having some manually explorable control range, to be moved within a predetermined setting range, and

b) stepwise expanding or reducing the displayed information within a respective expansion range in response to user-initiated movements of the control element, without a separate user action being required for a transition between the expansion or reduction steps.

Thus, in contrast to standard prior art display capabilities like zoom-in, zoom-out, or changing the size of any window, by whatever user action, which relates to capabilities provided by the GUI-capabilities of the Operating System, the present invention focuses the idea that the effects of those user-initiated movements of the setting means are pre-programmed from within the application program the user is running.

By that, the basic functional requirements are provided in order to enable a user, for example by moving a slider within a slider bar from one end to the other end of the setting range to make appear any additional information provided by the underlying program logic and to get a quick impression of the overall amount, i.e. quantity of information offered to him. Thus, by intuitively actuating the slider, the user may spontaneously decide in which detailed level he might have the time to fill-in possibly required GUI-controls, and to read through illustrative describing information. Thus, he will not waist unnecessary time for determining until which degree of details an information will be provided to him.

When the additional information is of the type read-only, i.e. is illustrative only, no essential rules must be followed when exploding the quantity of information or when reducing it, corresponding to the movement of the slider or any other control element. Advantageously, information given on a higher level should not hide information displayed on a lower level, e.g. revealing more details.

When some GUI-controls are getting part of an expanded form of display information, e.g., by moving the slider to some degree in the “more detailed” direction, and given the case the user fills in some detailed information, then, preferably this user-entered information is saved either for later use in the program, or for initially re-offering the data to the user if he decides to re-enter the same dialogue a second time. In the case the user fills in data within some detailed degree of display information and then goes back to the general level, it is proposed to use some default values instead of the user-selected values at least in those cases which are critical, seen from the applicational point of view.

When further, said GUI-controls comprises query means for creating a logical query, the user-interface is further improved for situations in which a user must define complex logical queries, e.g., in database applications.

When further, said query means comprises either of a variable identification, a logical operator, or an entry field for receiving characters or a numerical value, the processing of database queries is further improved, because such variable identification may for example identify a variable which is stored at any predetermined location in any given database table. Logical operators like OR, AND, GREATER THAN, etc. are well known in use with those queries. The present invention, however, makes the application thereof easy for the user to accomplish.

Further, the inventional, basic approach may be advantageously used in context with any kind of embedded system in which a customisation is required or optionally offered to the user.

Thus, also the personalisation dialogue of an embedded system may take profit of the invention. In these cases or in others it may be useful to include the step of checking user identification data and to limit the before-mentioned setting range specifically for the current user. By that, a quick overview can be achieved over the total of features allowed to be set in different authorisation levels.

### 3. BRIEF DESCRIPTION OF THE DRAWINGS

The present invention is illustrated by way of example and is not limited by the shape of the figures of the drawings in which:

FIG. 1 is a schematic representation illustrating the shape of a screen window according to three different slider bar positions in an exemplary form, and

FIG. 2 is a schematic representation illustrating the basics of the control flow in an embodiment of the inventional display method.

### 4. DETAILED DESCRIPTION OF THE PREFERRED EMBODIMENT

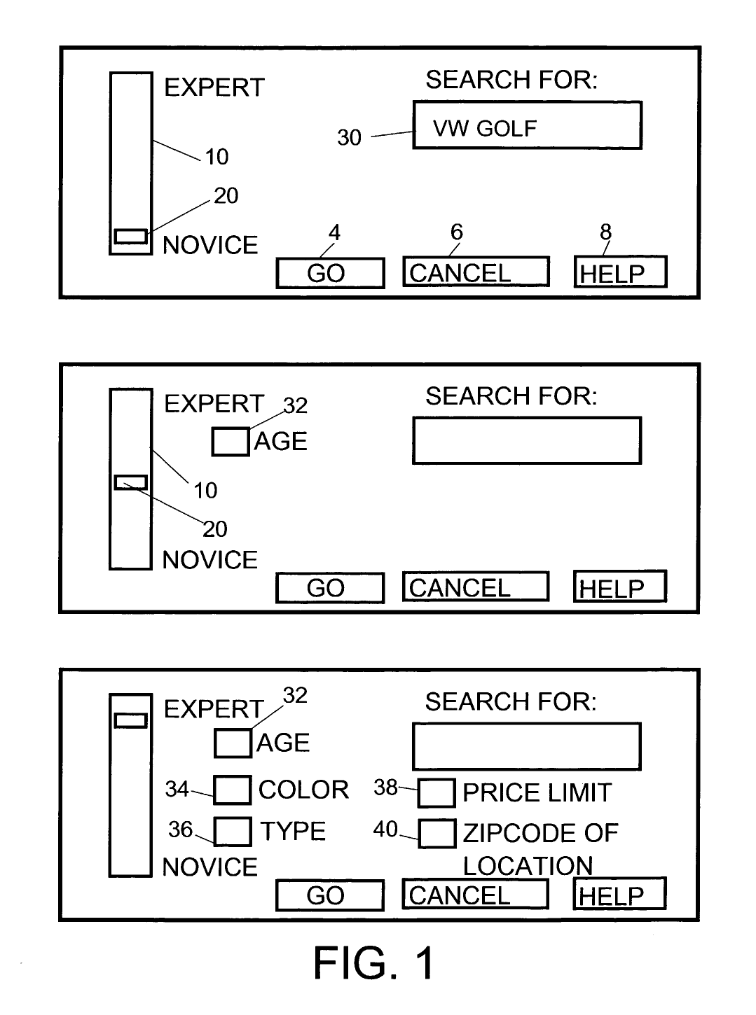

With general reference to the figures and with special reference now to FIG. 1 an exemplarily selected window design is taken as an example for an implementation of an embodiment of the present invention.

It is assumed that the windows depicted in FIG. 1 emerge when running an application program which deals with searching for used cars. A user of said application program first sees the standard window that is depicted on the top of FIG. 1.

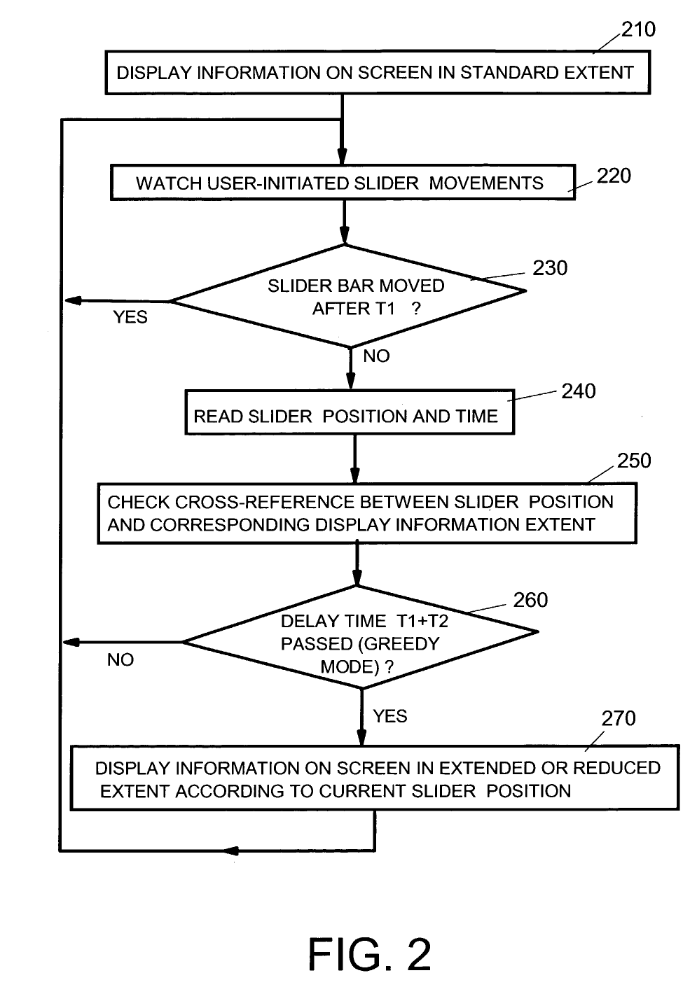

With additional reference to FIG. 2 this corresponds to step 210, in which information is displayed in a window according to a standard extent. Standard extent means in this exemplary case that this is equivalent to the minimum extent of display information. In other situations, however, the initial standard extent of display information may be chosen differently, for example with some more information.

It is assumed now that the user of the application program is interested in buying a particular used car which might be offered somewhere in a given geographical region that is covered by the data collection of the underlying application program. Thus, before the display of the upper window in FIG. 1 is done, the user is assumed to have entered the respective control information into said GUI-controls within said application program in order to arrive at a point in which he was guided to select used cars as an object of his personal search.

According to the particular embodiment of the present invention the application program implements some control algorithm, i.e. some watch dog function that watches any user-initiated slider bar movements after the window depicted in the upper portion of FIG. 1 once has been displayed, step 220.

As can be seen from FIG. 1, upper window, left margin, a slider bar 10 is included into the window comprising a slider 20 which is understood in here as a freely selected example for a setting means as a part of the man-machine interface. Said slider bar extends between two extreme ends of use levels: the lowest level is the so-called novice level and the second is the expert level. The slider may now be moved in the whole range between these two end positions. The novice end position, i.e. the lowest level requires the smallest quantum of user experience and user knowledge about the business process the application program is dealing with.

The expert level is the contrary in this regard, i.e., it requires the most additional user experience, but it allows for specifying the search for cars with a plenty of additional GUI-controls which may be advantageously used for specifying, i.e. detailing the search criteria in a way that allows the user to approach to some point in which the search results will mostly correspond to his desires.

Thus, the slider is shown in the novice position in the upper window of FIG. 1. It is shown in a middle position in the middle of FIG. 1 and is shown in the expert position at the top of the slider bar in the bottom window of FIG. 1. It should be assumed that—in order to keep the example as simple as possible—to limit the intermediate stages to that single middle position shown in the middle of FIG. 1. Thus, no more than 3 different slider positions can be realised that actually show some effect regarding to a reduced or extended display of information.

Further, in all of the three windows of FIG. 1 a search field 30 is provided in which the user is assumed to fill in the car producer name and the model of the car as e.g. fill in “VW Golf”. Further the commonly used GO-button 4, CANCEL-button 6 and HELP-button 8 are provided for starting the search, or cancelling a search and for requesting some help on a specific search, respectively.

According to the invention, far before entering any information into the search window 30 the user may now explore his search strategy in a very quick way. This can be intuitively done just by moving the slider 20 within the slider bar 10 from one end to the other and concurrently watch the effects of said slider movement. These effects are now exemplarily shown in FIG. 1 middle window and bottom window.

The inventional watch dog add-in program watches any user-initiated slider movements as it was mentioned above, step 220.

When some movement is now detected by the watchdog program, followed by a predetermined time T1 of non-movement, e.g., T1 set to 0,2 seconds, see the NO-branch in decision 230, the slider bar position is read from the graphical surface and is stored together with the system time, step 240.

Thus, it is continually checked if some predetermined delay time T1 has passed after the slider has been moved, see the NO-branch of decision 230 and was not further moved in between. Thus, for example, after the slider has been moved from the original novice position to the middle position depicted in the middle window of FIG. 1 and is not further moved by the user during for example 0,5 seconds, the slider position is read in step 240. This triggers a second time measurement used later for determining in decision 260 if a predetermined delay time T2 has passed or not. In the example given here said delay time is set to one second. This may be thus implemented basically comparable with the prior art ‘greedy’ mode, in which for example a descriptive explanation pops-up when the mouse pointer is navigated on a given control area, the function of which is considered to be accompanied by said explanation.

Before, or alternatively, after making the decision 260, in a step 250 a cross-reference table is accessed by the application program logic which is indexed by the slider position. A preprogrammed extent of display information is appended or uniquely mapped with each effective slider position, effective for the current window as this is depicted in FIG. 1.

Alternatively, or in combination therewith, the content expansion may be achieved by displaying one or more additional windows which offer enough space for each actually required extent of display information. Thus, in the application program some application program interface is proposed to be implemented which provides for accessing the above-mentioned cross-reference table.

Thus, in the particular, simple case depicted in FIG. 1 the table may comprise three rows and two columns. The three rows correspond to the three different levels which may be set by the users by moving the slider. In each row the slider bar position is stored together with the corresponding pointer to some methods and objects which are defined in the application program and can be accessed by the pointer of each row. Of course, regarding the program implementation itself, further different alternatives may be selected for the actual program implementation. This is thus not limiting the scope of the present invention.

In the YES-branch of 260, i.e. when the slider rested in the new position longer than T1+T2=1,2 seconds calculated by reading the system time (see above), the YES-branch of decision 260 is entered and the information is actually displayed on the screen in the extended form as it is depicted in FIG. 1, middle window. In particular, a further control box 32 pops-up within the window which opens up the possibility to the user to specify the maximum age of the car to be searched. Beyond this nothing changes in the window. This corresponds to step 270 in FIG. 2. Alternatively, this could also be a small checkbox accompanied by the pop-up of a second window dedicated for entering the age.

Thereafter it is branched back to step 220 in order to continue to watch the slider movements, step 220.

Then the control flow of FIG. 2 can be applied again for both directions, i.e. for returning to the novice level or for advancing to the expert level. In both cases the shape of the window changes:

In case of moving the slider to the expert position the window shape changes to that one given in the bottom part of FIG. 1.

The expert level is characterised in the specific example given here by providing some more GUI-controls in order to give some more details as a control input for the intended car search procedure. Thus, in addition to the age-field 32 four more boxes are given, i.e. box 34 for specifying the car-colour, box 36 for specifying the car-type, i.e. a Coupe or a Cabriolet or a Variant, etc., further a field 38 for specifying an upper price limit and a field 40 for specifying and limiting the geographical region in which the used car is located. Here, too, the same combinations and/or alternatives may be applied as mentioned above in context to age field 32.

Thus, as it should reveal from the above description of FIGS. 1 and 2 no intermediate user action is required for achieving the three window shapes depicted in FIG. 1, except the movement of the slider. Thus, laborious and time-consuming pressing of OK-buttons, or more buttons and the respective actuation of cancel-buttons are avoided according to the present invention.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

For example, the application program having implemented the features of the present invention may additionally display the setting level which was used at a former point in time in which it was installed at the hard disk of a desktop computer. Or in case of an embedded system the authorisation level or any other criterion which is important for the user or supervisor of the application program in question, may also be displayed.

It should be mentioned that the present invention has a specific advantage in context with small screens because it generally saves time when navigating through a user dialogue. In most cases said navigation is the more difficult the smaller is the available screen area.

The present invention can be realized in hardware, software, or a combination of hardware and software. A display tool according to the present invention can be realized in a centralized fashion in one computer system, or in a distributed fashion where different elements are spread across several interconnected computer systems, or as an Add-In in an application program. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following

a) conversion to another language, code or notation;

b) reproduction in a different material form.

1. A computerized method for displaying information on the screen of a computing device, the method including an application-driven, pre-programmed expansion or reduction of the quantity of information in response to an action triggered by a respective user of said computing device, characterized by the steps of:
a.) providing an user interface setting means (10,20) enabling a control element (20) thereof to be moved within a predetermined setting range, and
b) stepwise expanding (240, 250, 260, 270) or reducing (240, 250, 260, 270) the displayed information (32, 34, 36, 38, 40) within a respective expansion range in response (220, 230) to user-initiated movements of the control element (20), without a separate user action being required for a transition between the expansion or reduction steps, and the expansion or reduction being controlled by the application program.

2. The method according to claim 1 in which said information comprises GUI-controls (32, 34, 36, 38, 40) usable within an associated application program.

3. The method according to claim 1 in which said GUI-controls (32, 34, 36, 38, 40) comprises query means for creating a logical query.

4. The method according to claim 1 in which said query means comprises either of
a variable identification,
a logical operator, or
an entry field for receiving characters, or a numerical value.

5. The method according to the preceding claim, further comprising the step of
checking user identification data,
limiting said setting range specifically for a current user of a program.

6. The method according to claim 1, further comprising the step of:
expanding the display of information without hiding information already presented to the user before.

7. The method according to claim 1 or claim 2, in which a first limit of said range is associated with a display of summarized information,
and a second limit of said range is associated with a display of more detailed information.

8. The method according to claim 1 in which said user interface setting means (10,20) is a slider bar.

9. The method according to claim 1 or claim 2 used for an embedded system.

10. A computer system having means for performing the steps of a method according to one of the preceding claims 1 to 9.

11. The computer system according to the preceding claim, being an embedded system.

12. A computer program for execution in a data processing system comprising computer program code portions for performing respective steps of the method according to anyone of the preceding claims 1 to 9,
when said computer program code portions are executed on a computer.

13. A computer program product stored on a computer usable medium comprising computer readable program means for causing a computer to perform the method of anyone of the claims 1 to 9,
when said computer program product is executed on a computer.
